(19) United States
(12) Patent Application Publication
(10) Pub. No.: US 2014/0074268 A1
(43) Pub. Date: Mar. 13, 2014

(54) Method for Indexation and Level Classification of Kinesthetic Gifted Infants

(71) Applicant: Moon Hyung CHOI, Seoul (KR)

(72) Inventor: Moon Hyung CHOI, Seoul (KR)

(21) Appl. No.: 13/716,117

(22) Filed: Dec. 15, 2012

(30) Foreign Application Priority Data
Sep. 13, 2012 (KR) 10-2012-0101302

(51) Int. Cl. G06F 17/00

(52) U.S. Cl. CPC G06F 17/00
USPC 700/92

(57) ABSTRACT

Provided is a method for developing an assessment table which is used as a standard for measuring kinesthetic giftedness of preschoolers, that is, 5 to 7 years old infants, for indexation of the kinesthetic giftedness based on measured data for each section and factor using the assessment table, and for classifying the kinesthetic giftedness into levels, so as to identify and assess detailed abilities and potential of kinesthetic gifted infants.

### BACKGROUND

1. Field

The present invention relates to a method for indexation and level classification of kinesthetic gifted infants, especially to a method for developing an assessment table which is used as a standard for measuring kinesthetic giftedness of preschoolers, that is, 5 to 7 years old infants, for indexation of the kinesthetic giftedness based on measured data for each section and factor using the assessment table, and for classifying the kinesthetic giftedness into levels, so as to identify and assess detailed abilities and potential of kinesthetic gifted infants.

2. Description of the Related Art

These days, our societies are making efforts to cultivate gifted people with professional competence in each filed in order to develop social resources much more and use them effectively, and these efforts are made in a sports area as a form of sports giftedness development.

The sports giftedness development may be divided into two methods, and the former is detection of sports giftedness, that is, to detect people with potential and aptitude for general or specific sports, and the latter is selection of sports giftedness, that is, to predict what sports are suitable for a particular person.

The detection method of sports giftedness has a goal to explore children's giftedness and develop them from a long-term perspective, while the selection method of sports giftedness has a goal to pick up appropriate sportsmen in order to educate and train a specific sport from a shorter-term perspective.

Experts in measurement of sports giftedness have been discussing that the detection method of sports giftedness used to develop kinesthetic giftedness from a long term perspective requires to include environmental as well as hereditary information and to measure a variety of variables such as trainability, motor skills, physical variables, psychological variables, morphologic variables, etc.

In addition, many experts have conducted a long-term discussion that a number of steps would be needed to develop sports giftedness, and, after their opinions are synthesized, a procedure for developing sports giftedness is separated into three stages, that is, a stage of initiation, a stage of development, and a stage of perfection.

According to a majority of opinions, the stage of initiation is considered as infancy which is a stage before sports education begins, the stage of development is considered as childhood and adolescence in which sports education begins and the sports giftedness is developed, and the stage of perfection is generally considered as adulthood, that is, the period more than 18 years, even though being different from each sport.

Thus, in order to develop kinesthetic giftedness from a long term perspective, kinesthetic gifted children may be detected from their infancy and an appropriate measuring tool is required to be developed. However, a method for detecting kinesthetic giftedness in infancy between 5 and 7 years of age, that is, a multi-dimensional measuring tool consisting of a variety of variables is still undeveloped, and a method for indexation of kinesthetic giftedness for each section or factor and techniques for identification and classification by level of kinesthetic gifted children are also not generalized.

In addition, although the applicant has been conducting a study on verifying the validity of factors configuring kinesthetic giftedness of 5 to 7 years old infants, the study fails to provide a method and technique for identifying and classifying who are suitable for kinesthetic gifted children as well as levels to which the children belong, and moreover, a tool for measuring kinesthetic giftedness, which identifies and names kinesthetic gifted children among 5 to 7 years old infants, is uncompleted and undeveloped.

### SUMMARY

The task of the invention is applied to solve the defects, and is to provide an education direction and method for developing a multi-dimensional measuring tool which is used as a standard for measuring kinesthetic giftedness of 5 to 7 years old infants, for indexation and various level classification of the kinesthetic giftedness based on measured data for each section and factor according to criteria of the measuring tool so as to provide information on the kinesthetic giftedness, and moreover, for suggesting educational development tasks to improve the kinesthetic giftedness as well as for helping general development of the kinesthetic giftedness during a whole lifetime.

In order to accomplish the above object, the present invention provides a method for indexation and level classification of kinesthetic gifted infants comprising of: processing a pretest score (a) in which a measuring tool for measuring kinesthetic giftedness of 5 to 7 years old infants is developed and an assessment standard is established, and a score for each section including fundamental movement, fitness, and sports achievement motivation sections as well as a measured score for each detailed factor corresponding to the each section are drawn using the standard, and then the scores are inputted through an input and a controller receiving the inputted score classifies the inputted scores by corresponding section and factor to calculate a raw score through a pretest score processing unit; calculating a standardized score (b) in which the controller converts the raw score calculated through classification according to each section and factor into a standardized score according to gender and age of participants and then calculates a standardized score for each section and factor; calculating a gifted children index (c) in which the controller substitutes the calculated standardized score for each section and factor with an index calculation formula and then calculates a gifted children index through a gifted children index calculating unit; classifying by level (d) in which the controller performs clustering of the calculated standardized score for each section, separates the clustering result into a plurality of bands, and classifies by level so as to make a classification judgment after distribution according to each band through a cluster analyzing unit; and outputting (e) in which the controller stores the calculated indexes and classified levels into a database, and outputs the indexes and levels through a display.

In addition, according to the present invention, the classification by factor in step (a) includes basic locomotive movement, combination locomotive movement, general manipulative movement, specific manipulative movement, stability movement, health-related fitness, performance-related fitness, and sports achievement motivation factors.

Furthermore, according to the present invention, the index calculation formula in step (c) may be applied in the following form: (obtained score/mean score)×100+((average months of age—monthly age of participant)×constant of difference between monthly ages).

Moreover, according to the present invention, k-means and Self-Organizing Map (SOM) which are used for a cluster analysis may be applied to the clustering according to section in the step (d).

### BRIEF DESCRIPTION OF THE DRAWINGS

FIG. 1 is a block diagram illustrating a device for indexation and level classification of kinesthetic gifted infants according to the present invention.

FIG. 2 a block diagram illustrating a controller for indexation and level classification of kinesthetic gifted infants according to the present invention.

FIG. 3 is a flow chart of a method for indexation and level classification of kinesthetic gifted infants.

FIG. 4A is a table of means of kinesthetic gifted children for each section according to age and gender in order to perform indexation and level classification of kinesthetic gifted infants in the present invention.

FIG. 4B is a table of means of kinesthetic gifted children for each factor according to age and gender in order to perform indexation and level classification of kinesthetic gifted infants in the present invention.

FIG. 4C is a table of mean values and proportions of clustering for each section according to a standardized score of each infant group in order to perform indexation and level classification of kinesthetic gifted infants in the present invention.

FIG. 4D is a table of criteria for classification judgment of kinesthetic gifted children according to each level in order to perform indexation and level classification of kinesthetic gifted infants in the present invention.

FIGS. 5A to 8 are assessment tables developed in the present invention in order to be used as standards for measuring kinesthetic gifted infants.

### DETAILED DESCRIPTION

Hereinafter, a method for indexation and level classification of kinesthetic gifted infants according to the present invention will be described in detail with reference to the appended drawings.

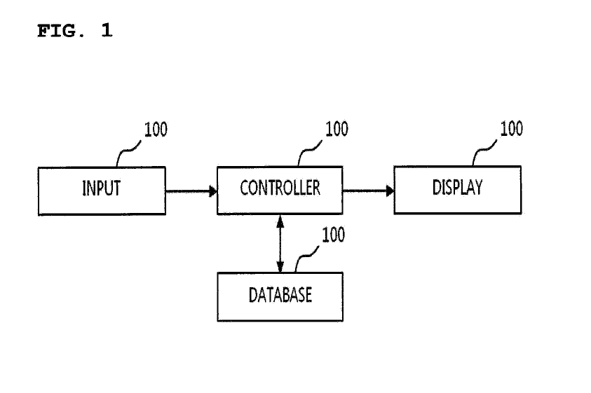

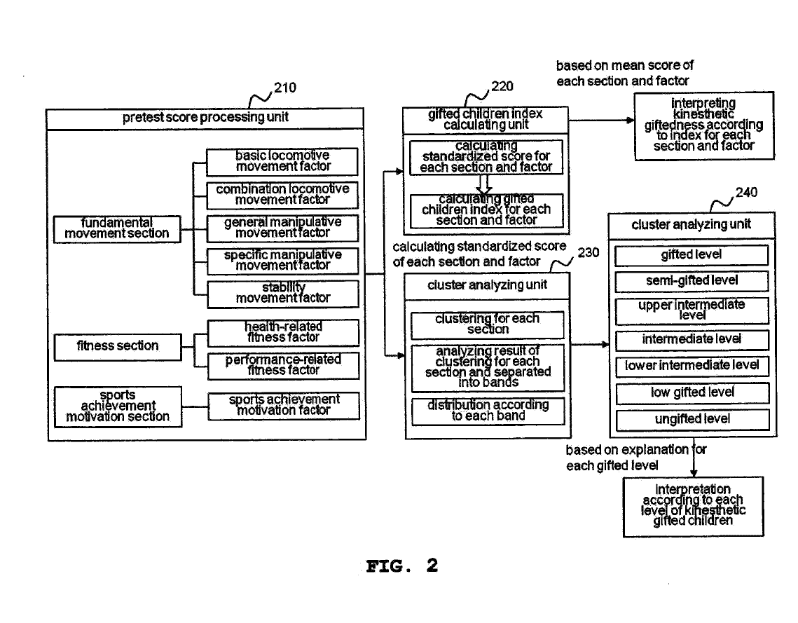

In FIG. 1, a device for indexation and level classification of kinesthetic gifted infants provides an input 100 which inputs measured data of a corresponding infant according to an assessment table used as a standard for measuring kinesthetic giftedness of infants. In case of the input 100, the measured data may be manually inputted by a user, or may be automatically inputted by a device for measuring the corresponding infant according to each section and factor, that is, an automated measuring device.

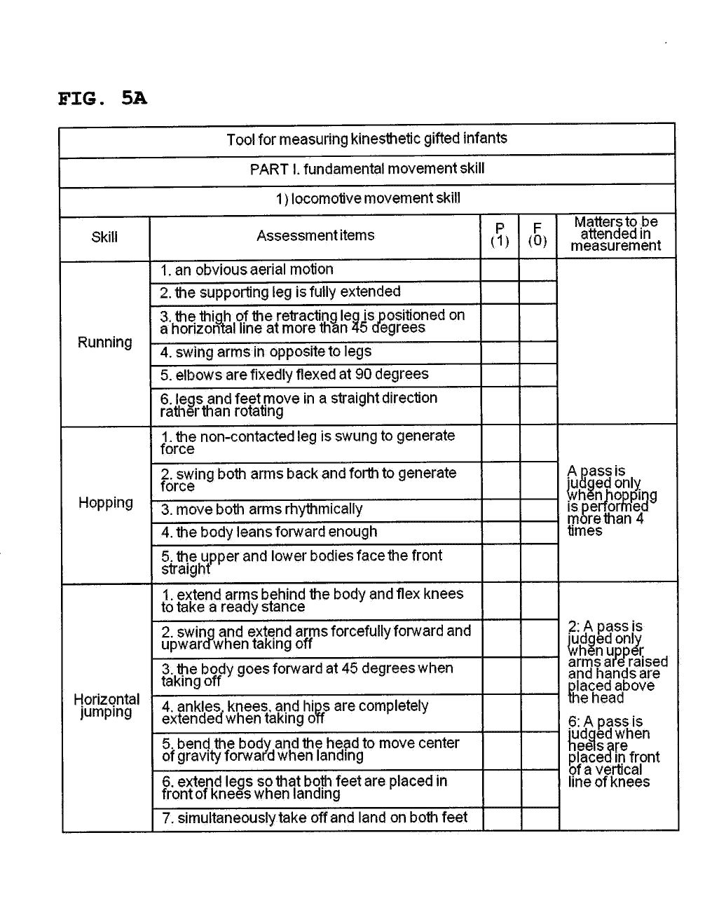

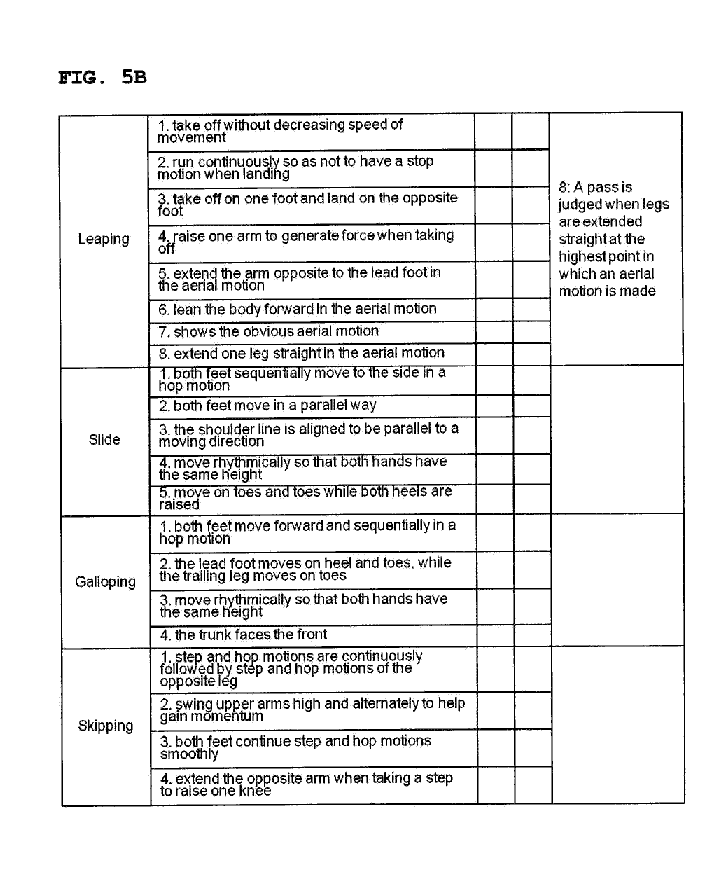

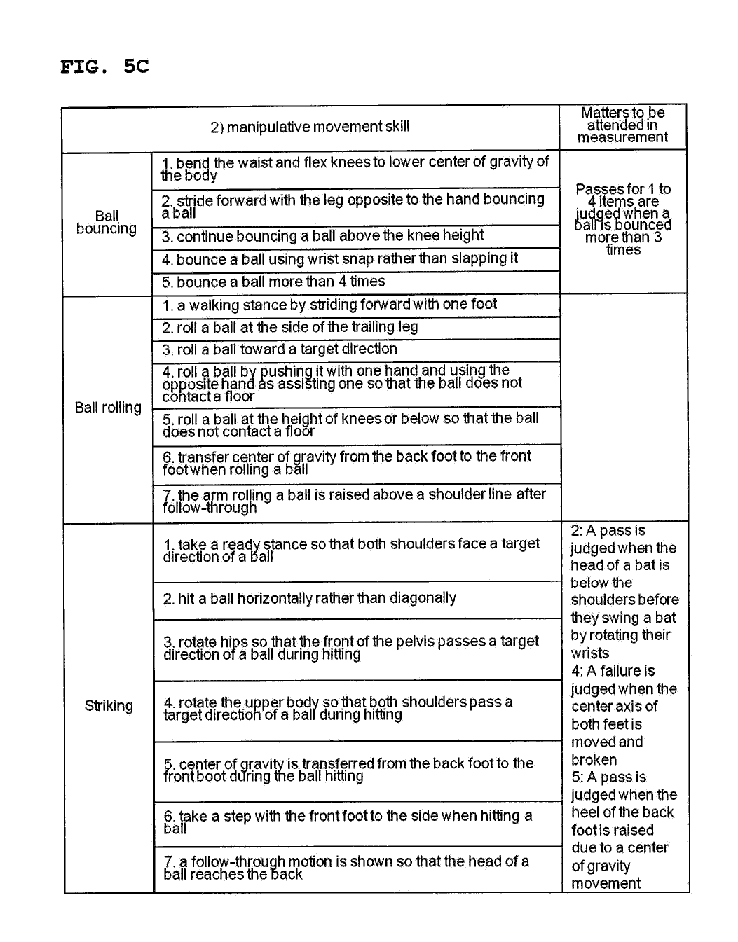

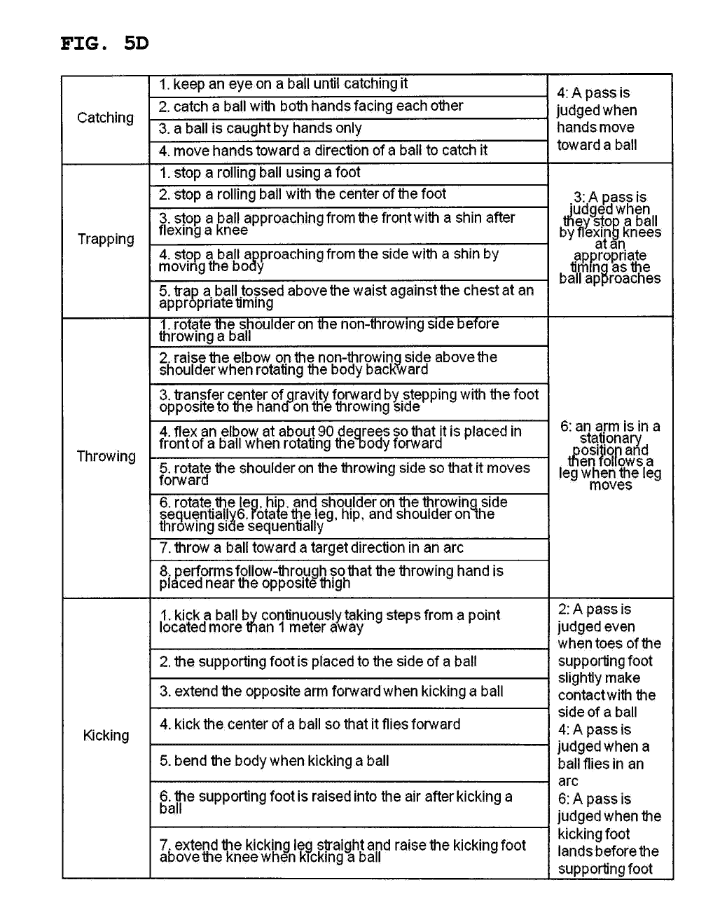

In addition, a controller 200 includes detailed units for processing a pretest score, calculating a gifted children index, analyzing clusters, and classifying by level in regard to the measured data inputted from the input. According to the detailed configuration of the controller 200, a pretest score processing unit 210 summates raw measured data, which is inputted from the input 100, numerically provided according to each section as well as each detailed factor in the corresponding section. And the pretest score processing unit 210 calculates the summated measured data into a standardized score. That is, the measured data for the each corresponding section and factor of FIGS. 5A to 8 obtained according to an assessment table used as a standard for measuring kinesthetic giftedness of infants is separated into three sections, that is, fundamental movement, fitness, and sports achievement motivation sections, wherein the fundamental movement section includes basic locomotive movement, combination locomotive movement, general manipulative movement, specific manipulative movement, and stability movement factors, the fitness section includes health-related fitness and performance-related fitness factors, and the sports achievement motivation section includes a sports achievement motivation factor.

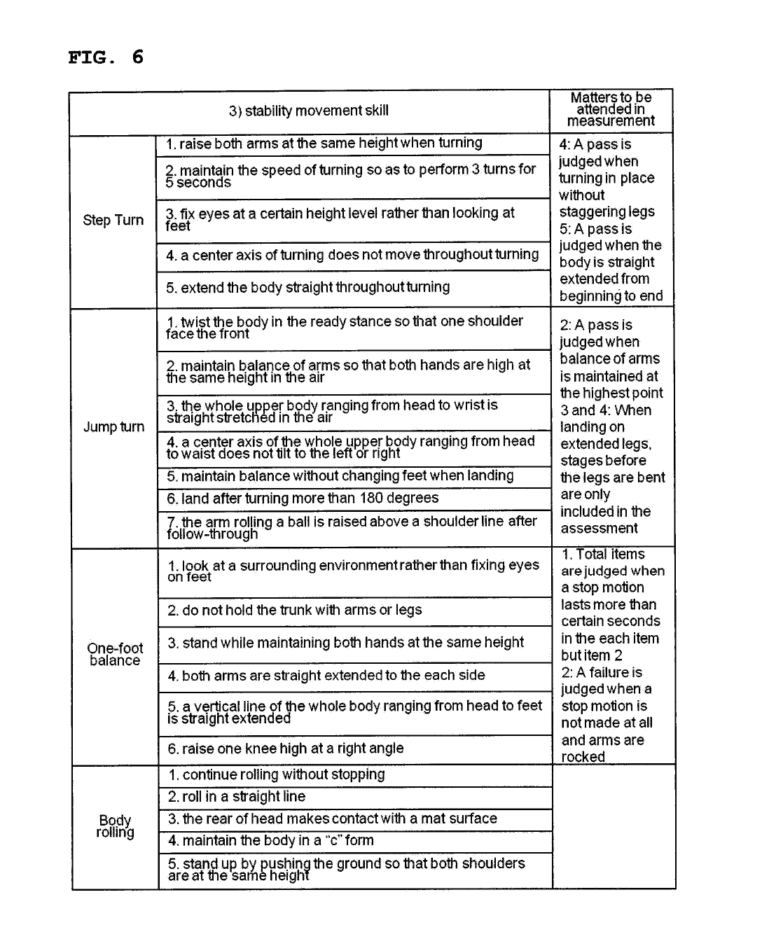

FIGS. 5A to 6 are tables of a fundamental movement section processed in the pretest score processing unit, and include detailed skills, assessment items, passes or failures, and matters to be attended in measurement. According to the fundamental movement section, locomotive movement factors include running, hopping, horizontal jumping, leaping, slide, galloping, and skipping, manipulative movement factors include ball bouncing, ball rolling, striking, catching, trapping, throwing, and kicking, and stability movement factors include step turn, jump turn, one-foot balance, and body rolling.

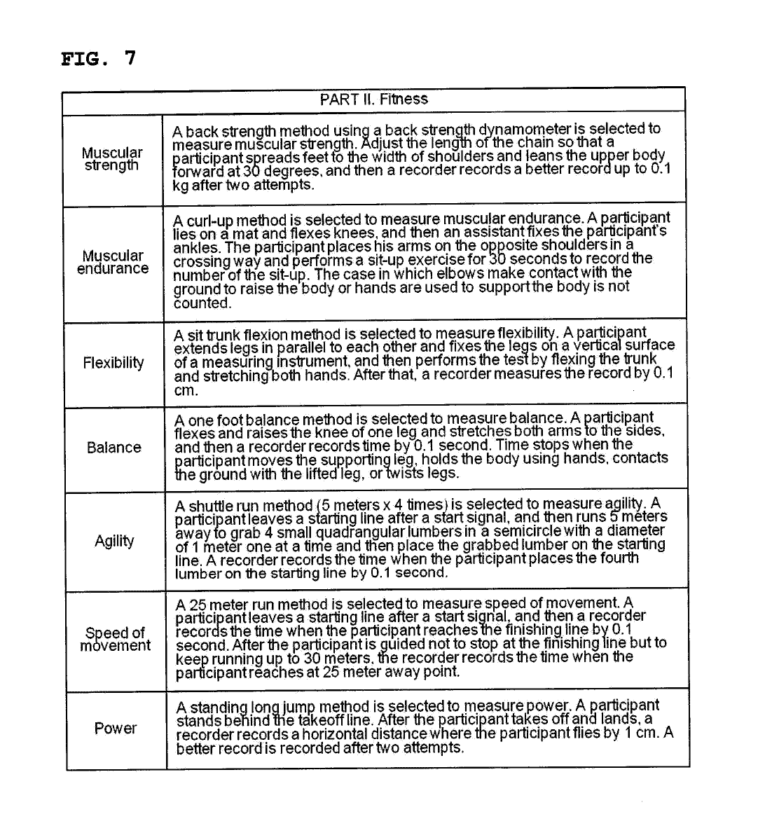

FIG. 7 is a table of a fitness section processed in the pretest score processing unit, and includes muscular strength, muscular endurance, flexibility, balance, agility, speed of movement, and power.

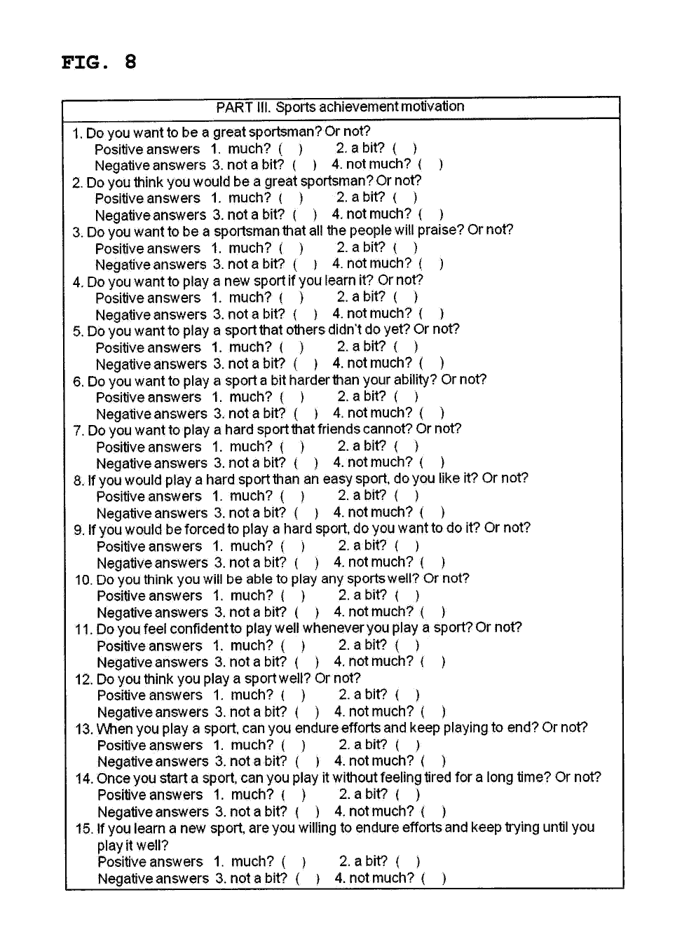

FIG. 8 is a table of a sports achievement motivation section processed in the pretest score processing unit, and includes positive or negative answers to a plurality of question items.

A gifted children index calculating unit 220 of the controller 200 calculates a kinesthetic giftedness index according to gender and age of a corresponding infant using a standardized score for each section and factor calculated in the pretest score processing unit 210. A formula for calculating the kinesthetic giftedness index is applied in the following form: (obtained score/mean score)×100+((average months of age—monthly age of participant)×constant of difference between monthly ages). The index calculation formula is applied to calculate the one index for section as well as the other index for factor so that indexation of kinesthetic giftedness is made. The kinesthetic giftedness according to the index for each section and factor obtained on a basis of a mean score for each section and factor calculated in the kinesthetic gifted children index calculating unit 220 is stored in a database 300, while at the same time being displayed through a display 400. The kinesthetic giftedness for each section and factor is interpreted based on the index displayed on the display 400.

In addition, a cluster analyzing unit 230 in the controller 200 summates scores for each factor in the fundamental movement, fitness, and sports achievement motivation sections, and then converts the summated scores into a standardized score of each group (T-score) according to gender and age and summates the converted scores. Groups are analyzed using k-means and Self-Organizing Map (SOM) clustering used to analyze clusters for each section through clustering for the each section, based on the calculated standardized scores for the three sections. Here, the k-means is a segmentation method for analyzing a clustering, and a data set D having n number of objects as well as the number of clusters k are provided. A segmentation algorithm divides the objects into k number of clusters. Consequently, the objects in a cluster are similar with each other, while the objects in different clusters are not similar with each other. Procedures of the k-means are performed in the following sequence: k is randomly extracted from the objects as a mean or central value of a cluster, the remaining objects are assigned to the closest and the most similar cluster on a basis of the objects and a cluster mean, and the above-mentioned sequences are repeated until a critical value or a criterion function converges after a new mean is obtained in each cluster. A square error is generally used for the criterion function. Also, the SOM adjusts a weight so that input vectors are matched in a training set, and is one of Unsupervised Learning methods on a basis of an artificial network. And a Winner-Take-All course, that is, a kind of Competitive Network, declares a node having a weight vector closest to an input vector as a winner and adjusts the weight so that the value becomes closer to the input vector.

Furthermore, the cluster analyzing unit 230 separates the result of the clustering analysis into a plurality of bands, and then distributes a mean value and proportion of the clustering for each section according to gender and age.

Moreover, a classifying by level unit 240 of the controller 200 separates characteristics in each section of the assessment table, which is used as a standard for measuring kinesthetic giftedness of infants, into seven levels. That is, a gifted level represents a group having very high scores in the fundamental movement, fitness, and sports achievement motivation sections, and a semi-gifted level represents a group having a bit lower scores in the fundamental movement and fitness sections than the gifted level and having much higher scores in the sports achievement motivation section than the gifted level. And upper intermediate, intermediate, lower intermediate levels respectively have high, middle, and low scores in the fundamental movement and fitness sections, but have a small difference of scores in the sports achievement motivation section between the three levels. Low gifted and ungifted levels respectively have low scores in the fundamental movement, fitness, and sports achievement motivation sections, but the scores of the low gifted level is higher than that of the ungifted level.

The levels of kinesthetic gifted children based on an explanation for the each gifted level classified in the classifying by level unit 240 are stored in the database 300, while at the same time being displayed through the display 400. The kinesthetic giftedness is interpreted based on the levels displayed on the display 400.

The database 300 stores data inputted to and outputted from the controller 200, and the display 400 visually displays the result obtained through the indexation and level classification of kinesthetic gifted infants. Also, data remotely inputted from a terminal through an online network such as the Internet may be processed after the controller 200 is configured as a server and a website is constructed, and then the result of level classification and a giftedness index may be transmitted to the corresponding terminal.

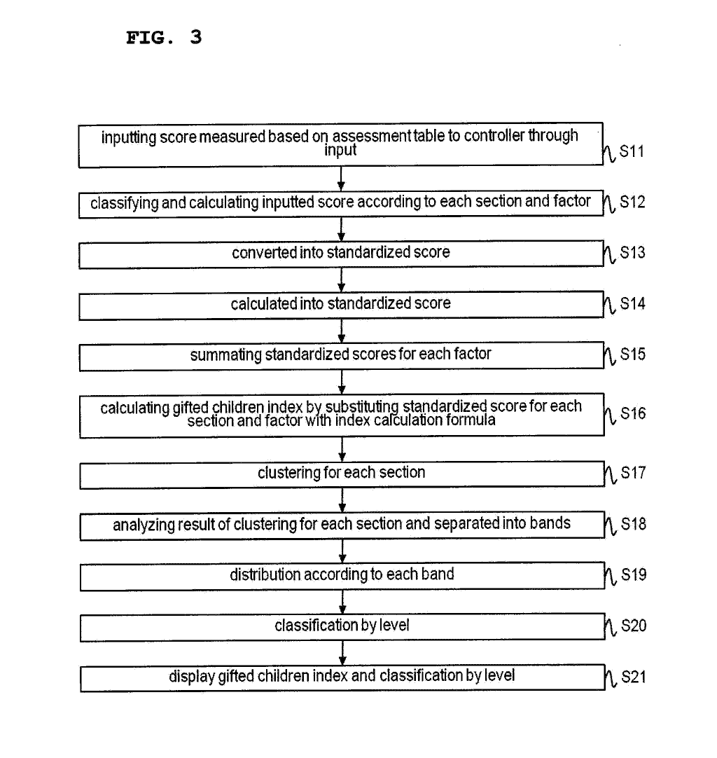

A method for calculating an index for each section and factor and making level classification of kinesthetic giftedness of infants according to the present invention having such a configuration is described with reference to a flow chart in FIG. 3.

First of all, in a step of processing a pretest score according to an assessment table which is used as a standard for measuring kinesthetic giftedness of infants as shown in FIGS. 5A to 8, measurement is performed according to the assessment table used as a standard for measuring kinesthetic giftedness of infants and then measured scores are inputted to the controller 200 through the input 100. (S11) And raw scores corresponding to three sections, that is, fundamental movement, fitness, and sports achievement motivation sections as well as eight factors according the sections, that is, basic locomotive movement, combination locomotive movement, general manipulative movement, specific manipulative movement, stability movement, health-related fitness, performance-related fitness, and sports achievement motivation factors are classified and calculated. (S12) Besides, Sections of a test for identifying kinesthetic gifted children are separated into fundamental movement, fitness, and sports achievement motivation sections. These sections are detailedly separated into factors, wherein the fundamental movement section is separated into a basic locomotive movement factor consisting of running, hopping, leaping, horizontal jumping, etc., a combination locomotive movement factor consisting of galloping, slide, skilling, etc., a general manipulative movement factor consisting of catching, striking, throwing, kicking, etc., a specific manipulative movement factor consisting of ball rolling, trapping, ball bouncing, etc., and a stability movement factor consisting of axial movement, spring movement, upright support, inverted support, etc. The fitness section is separated into a health-related fitness factor consisting of muscular strength, muscular endurance, flexibility, etc., and a performance-related fitness factor consisting of agility, speed of movement, power, balance, etc., and the sports achievement motivation section includes a single sports achievement motivation factor consisting of aspiration level, adventurousness, achievement task preference, self-confidence, and endurance.

Next, in a step of calculating a standardized score, the controller 200 converts a raw score calculated and classified by section and factor into a standardized score according to gender and age of participants, and then calculates a standardized score for each section and factor.

In this step, first, the standardized score for the each section is calculated. Raw scores for test items of 18 skills in the fundamental movement section, that is, running, hopping, horizontal jumping, leaping, galloping, skipping, slide, throwing, kicking, striking, catching, ball bouncing, ball rolling, trapping, axial movement, spring movement, upright support, and inverted support skills, are summated, and then the summated raw scores are converted into standardized scores (T-score) according to age and gender groups. And raw scores for test items in the fitness section, that is, muscular strength, muscular endurance, flexibility, balance, agility, speed of movement, and power items, are converted into standardized scores (T-score) corresponding to age and gender groups and then the converted scores are summated. Raw scores for 15 items in the sports achievement motivation section are summated and then converted into standardized scores (T-score) according to age and gender groups. (S13) After that, a standardized score for the each factor is calculated. (S14)

Raw scores for test items corresponding to each of the factors, that is, basic locomotive movement, combination locomotive movement, general manipulative movement, specific manipulative movement, stability movement, and sports achievement motivation factors, are summated and then converted into standardized scores (T-score) according to age and gender groups. Raw scores for test items corresponding to each of the factors, that is, health-related fitness and performance-related fitness factors, are converted into standardized scores (T-score) according to age and gender groups, and then summation for the each factor is performed. (S15)

Next, in a step of calculating kinesthetic gifted children index, the controller 200 substitutes the standardized score for the each section and factor calculated through the kinesthetic gifted children index calculating unit 220 with an index calculation formula, and then calculates a gifted children index.

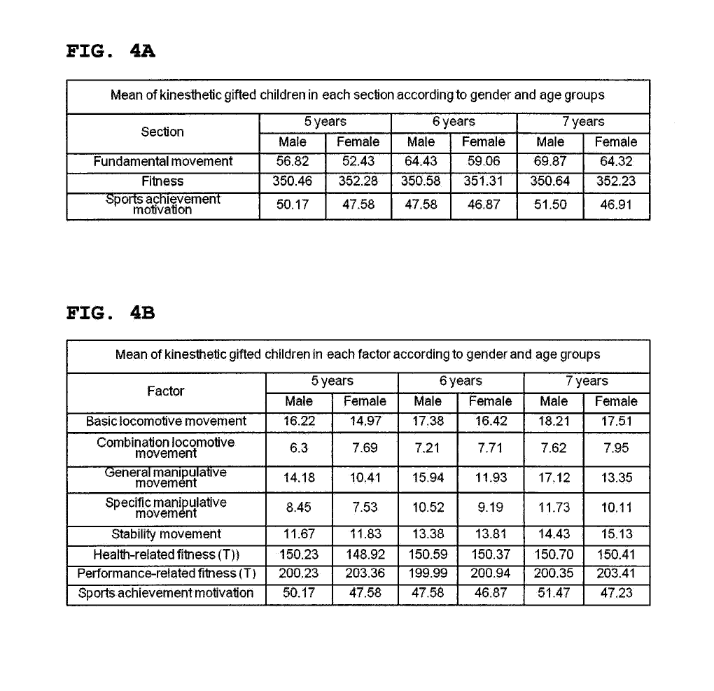

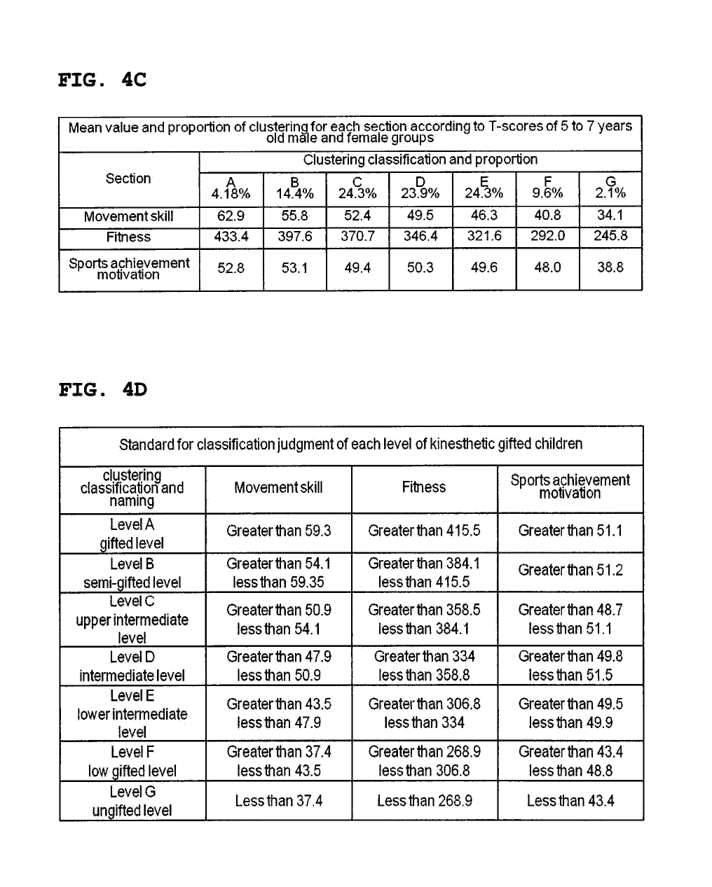

Procedures of calculating a kinesthetic gifted children index for each section is performed based on the mean score table in FIG. 4A in order to calculate the kinesthetic gifted children index for each section according to gender and age in the kinesthetic gifted children index calculating unit 220. The kinesthetic gifted children index for each section is calculated through the following formula: (obtained score/mean score)×100+((average months of age—monthly age of participant)×constant of difference between monthly ages). (S16) For example, a method for calculating the kinesthetic gifted children index of the fundamental movement section is described as follows: a 63 months old male participant A has a measured score of 70 in the fundamental movement section. Here, when a 6 years old male has a mean score of 64.43 in the fundamental movement section and a constant of difference of±1 month is 1.5 based on 66 months age, the kinesthetic gifted children index of the fundamental movement section is calculated according to the formula as follows: (70/64.43)×100+((66-63)×1.5), and thus, the gifted children index becomes 113.

Such a result is stored in the database 300 by the controller 200 and displayed through the display 400. An interpretation of kinesthetic giftedness according to the index for each section is performed, based on the displayed result. Kinesthetic giftedness indexes of the fitness and sports achievement motivation sections are also analyzed through the above-mentioned method.

In addition, procedures for calculating a kinesthetic gifted children index for each factor is performed based on the mean score table in FIG. 4B in order to calculate the kinesthetic gifted children index for each factor according to gender and age. The kinesthetic gifted children index for each factor is calculated through the following formula: (obtained score/mean score)×100+((average months of age—monthly age of participant)×constant of difference between monthly ages). For example, a 63 months old male participant A has a measured score of 20 in the general manipulative movement factor. Here, when a 6 years old male has a mean score of 15.94 in the general manipulative movement factor and a constant of difference of ±1 month is 1 based on 66 months age, the kinesthetic gifted children index of the manipulative movement factor is calculated according to the formula as follows: (20/15.94)×100+((66-63)×1), and thus, the gifted children index of the general manipulative movement factor becomes 128. An interpretation of the kinesthetic giftedness according to the index for each factor is performed, based on such a result. Kinesthetic giftedness indexes according to other factors are also analyzed through the above-mentioned method.

Next, in a step of classifying by level, the controller 200 performs clustering of the calculated standardized score for each section, separates the clustering result into a plurality of bands, and classifies by level in order to make classification judgment of kinesthetic gifted children after distribution according to the each band. A cluster analysis of the whole sections is separated into fundamental movement, fitness, and sports achievement motivation sections. Scores of the fundamental movement section are calculated in such a way that total scores of the whole factors in the corresponding section are summated, and then the summated scores are converted into standardized scores of groups (T-score) according to gender and age. Scores of the fitness section are calculated in such a way that items corresponding to health-related fitness and performance-related fitness factors are converted into standardized scores of groups (T-score), and then the converted standardized scores are summated. Scores of the sports achievement motivation section are calculated in such a way that raw scores of a sports achievement motivation factor are summated, and then the summated raw scores are converted into standardized scores of groups (T-score). The classification by level of kinesthetic gifted children is performed through the cluster analysis of the whole factors, based on the standardized scores (T-score) for the three sections. That is, clustering of the scores for each section calculated through the clustering for each section (S17) is performed using k-means and SOM clustering methods, so that groups are analyzed. The analyzed is separated into seven bands, that is, A, B, C, D, E, F, and G groups as shown in FIG. 4C, based on the result of the clustering analysis. (S18) After that, a mean value and proportion of the clustering for each section according to gender and age are analyzed, based on the distribution according to each band (S19), and then, finally, criteria for the classification judgment according to level of kinesthetic gifted children are established, as shown in FIG. 4D (S20). The result in FIG. 4D shows a characteristic of each section in an assessment table which is used as a standard for measuring kinesthetic gifted infants. A gifted level is a group having very high scores in the fundamental movement, fitness, and sports achievement motivation sections, and a semi-gifted level represents a group having high scores in the fundamental movement and fitness sections, while at the same time having much higher scores in the sports achievement motivation section than the gifted level. Upper intermediate, intermediate, lower intermediate levels respectively have high, middle, and low scores in the fundamental movement and fitness sections and have a small difference of scores in the sports achievement motivation section between the three levels, but the intermediate level has higher scores in the sports achievement motivation section than the upper intermediate level. Low gifted and ungifted levels respectively have low scores in the fundamental movement, fitness, and sports achievement motivation sections, but the scores of the low gifted level is higher than that of the ungifted level.

As described above, according to the calculated gifted children index and classification by level, the controller 200 performs a step of storing the calculated indexes and classified levels in the database 300 and displaying the indexes and levels through the display 400. (S21) Accordingly, levels of kinesthetic gifted children may be interpreted, based on the judgment for levels of the each section. Moreover, a test performed according to an assessment table used as a standard for measuring kinesthetic giftedness of infants is analyzed, so that a method for generating an index for each section and factor of kinesthetic children, for interpreting the generated kinesthetic giftedness index for each section and factor, and for classifying kinesthetic gifted children groups by level and understanding characteristics of the each classified level is provided.

Indexation of the kinesthetic giftedness may be perform and classification judgment for each level of kinesthetic gifted children may also be perform through indexation for each section and factor, and thus, kinesthetic gifted children may be identified. And moreover, the kinesthetic gifted children are classified into detailed levels, and thus, a more detailed assessment of the kinesthetic gifted children as well as development of giftedness according to characteristics in each group may be promoted.

According to the present invention, data measured through a tool for measuring kinesthetic giftedness of 5 to 7 years old infants, that is, an assessment table which is used for a standard, is analyzed, an index of kinesthetic gifted children is generated according to each section and factor, the generated index of kinesthetic gifted children according to each section and factor is interpreted, groups of kinesthetic children are classified by level, and characteristics in the each level are understood, and thus, there are the following advantages: first, indexation of kinesthetic giftedness of infants may be performed and the kinesthetic gifted children are distinguished and classified according to each level, so that children suitable for kinesthetic gifted children may be easily identified; second, kinesthetic giftedness is classified into seven levels, that is, gifted, semi-gifted, upper intermediate, intermediate, lower intermediate, low gifted, and ungifted levels, instead of a dichotomous division simply separating the children into kinesthetic gifted and ungifted groups, so that the kinesthetic giftedness may be more detailedly assessed; and third, characteristics in the each level are understood, so that the giftedness may be developed.

Although specific embodiments of the present invention have been shown and described by drawings, it will be apparent to those skilled in the art that various modifications and variations can be made in the present invention without departing from the spirit or scope of the present invention descried in the appended claims.

What is claimed is:

1. A method for indexation and level classification of kinesthetic gifted infants, comprising:
processing a pretest score (a) in which an assessment tool for measuring kinesthetic gifted infants between 5 to 7 years of age is developed and an assessment standard is established, and a score for each section including fundamental movement, fitness, and sports achievement motivation sections as well as a measured score for each detailed factor corresponding to the each section are drawn using the standard, and then the scores are inputted through an input and a controller receiving the inputted score classifies the inputted scores by corresponding section and factor to calculate a raw score through a pretest score processing unit;
calculating a standardized score (b) in which the controller converts the raw score calculated through the classification by section and factor into a standardized score according to gender and age of participants, and then calculates a standardized score for each section and factor;
calculating a gifted children index (c) in which the controller substitutes the calculated standardized score for each section and factor with an index calculation formula, and then calculates a gifted children index through a gifted children index calculating unit;
classifying by level (d) in which the controller performs clustering of the calculated standardized score for each section, separates the clustering result into a plurality of bands, and classifies by level so as to make classification judgment after distribution according to the band through a cluster analyzing unit; and
outputting (e) in which the controller stores the calculated indexes as well as classified levels into a database and outputs the indexes and levels through a display.

2. The method for indexation and level classification of kinesthetic gifted infants according to claim 1, wherein, in step (a), the method comprises an assessment table of a tool for measuring kinesthetic gifted infants which is used as a standard for calculating scores for each section including fundamental movement, fitness, and sports achievement motivation sections as well as for each detailed factor according to the corresponding section.

3. The method for indexation and level classification of kinesthetic gifted infants according to claim 1, wherein, in step (a), the classification by factor comprises basic locomotive movement, combination locomotive movement, general manipulative movement, specific manipulative movement, stability movement, health-related fitness, performance-related fitness, sports achievement motivation factors.

4. The method for indexation and level classification of kinesthetic gifted infants according to claim 1, wherein, in step (C), the index calculation formula is applied in the following form: (obtained score/mean score)×100+((average months of age—monthly age of participant)×constant of difference between monthly ages).

5. The method for indexation and level classification of kinesthetic gifted infants according to claim 1, wherein, in step (d), k-means and Self-Organizing Map (SOM) used for a cluster analysis are applied to the clustering for each section.
